(19) United States
(12) Patent Application Publication
(10) Pub. No.: US 2026/0302470 A1
(43) Pub. Date: Oct. 1, 2026

(54) BATTERY ENCLOSURE

(71) Applicant: Dyson Technology Limited, Malmesbury, Wiltshire (GB)

(72) Inventors: Firas ZEINEDDINE, Bristol (GB); Sean CREED, Chippenham (GB); James Thomas WRIGHT, Bristol (GB); Edward Hugh BURDEN, Stroud (GB); Ali AL-RUBEI, Swindon (GB)

(21) Appl. No.: 19/477,818

(22) PCT Filed: Apr. 10, 2024
(86) PCT No.: PCT/IB2024/053493

§ 371 Date: Oct. 23, 2025

(30) Foreign Application Priority Data
Apr. 27, 2023 (GB) 2306192.2

(51) Int. Cl. H01M 50/242; H01M 10/04; H01M 50/211

(52) U.S. Cl. CPC H01M 50/242; H01M 10/0481; H01M 50/211

(57) ABSTRACT

A pouch cell battery including a pouch cell enclosure and one or more pouch cells. The pouch cell enclosure includes first and second compression members spaced apart in a cell stack direction to define a cell-receiving space therebetween for receipt of one or more pouch cells. The first and second compression members are moveable relative to one another in the cell stack direction. The enclosure further includes a biasing arrangement connecting the first and second compression members and urges the first and second compression members towards one another. The one or more pouch cells are disposed in the cell-receiving space of the pouch cell enclosure, between the first and second compression members.

### BACKGROUND

Batteries, such as those used in consumer devices, are typically formed of a plurality of battery cells (or just “cells”). Battery cells (such as lithium-ion cells) come in various formats. Known battery cells often have a cylindrical shape or a rectangular (or cuboid) shape. One type of rectangular battery cell that is increasingly being used in devices is a pouch cell. A pouch cell includes a laminated battery architecture contained within a flexible (i.e. non-rigid) pouch, which is commonly formed of a plastic coated aluminium film. Tabs are provided at one end (or two opposite ends) of the pouch cell to provide terminals that allow electrical connection of the pouch cell to other pouch cells in a pouch cell stack or to other electrical components of a device.

The use of a pouch rather than a rigid housing (as is the case with other types of battery cell) reduces the overall weight and volume of the cell. Likewise, the rectangular (or cuboid) shape provides a more efficient use of space than a cylindrical shape when multiple cells are packaged together. (i.e. in a cell stack)

The flexible nature of the pouch of a pouch cell, however, means that an enclosure must be provided to protect the pouch cell (or a stack of pouch cells) of a battery against damage. One characteristic of pouch cells (such as lithium-ion pouch cells) is that each charge and discharge cycle of the pouch cell can result in expansion and contraction of the pouch cell. Likewise, for performance reasons, it is desirable to maintain compression of pouch cells through each charge and discharge cycle. Thus, pouch cells must be packaged in a way that accommodates this expansion and contraction while maintaining compression.

To achieve this, pouch cell stacks are typically packaged in a rigid enclosure with foam provided between each cell, and between the outermost cells and the enclosure (i.e. the foam it typically arranged in series with the pouch cells). As the cells expand, the foam is compressed, which provides a reactionary force to maintain compression of the cells.

### SUMMARY

In a first aspect there is disclosed a pouch cell enclosure comprising:
first and second compression members spaced apart in a cell stack direction so as to define a cell-receiving space therebetween for receipt of one or more pouch cells, the first and second compression members being moveable relative to one another in the cell stack direction; and
a biasing arrangement connecting the first and second compression members and configured to urge the first and second compression members towards one another.

The pouch cell enclosure of the first aspect can be of reduced dimension in the cell stack direction compared to known arrangements that make use of foam for compression as discussed above.

One problem that is inherent in the use of foam is that it is only able to compress to a certain strain for a given cell expansion. In other words, at maximum compression of the foam (being maximum expansion of the cell(s)), the foam still has some residual thickness. This residual thickness must be accounted for in the overall dimension of the battery in the cell stack direction, resulting in a larger battery (at least in the cell stack direction). This issue is exacerbated by the fact that pouch cell batteries typically contain a plurality of cells in a stack with several layers of foam.

Another potential problem with the use of foam is that at least some types of foam material are susceptible to decomposition in thermal runaway events. A thermal runaway event occurs when a battery reaches an elevated temperature, causing a chain reaction that ultimately results in a very rapid rise in the temperature of the battery. Not only is decomposition of the foam undesirable but, in some cases, the use of foam between cells can also increase the likelihood of reaching those elevated temperatures because it can act as an insulator.

The arrangement of the first aspect removes the need to use foam in the enclosure. This can result in an enclosure of reduced dimension in the cell stack direction (because the enclosure does not need to accommodate the additional foam layers). Likewise, the removal of foam can reduce the likelihood of a cell reaching the elevated temperatures required for a runaway event, because (in the absence of the foam layers) heat is able to be transferred from the cell to any surrounding cells and/or the enclosure.

Accordingly, the pouch cell enclosure of the first aspect may be more compact (at least in the cell stack direction) and may be less likely to undergo a thermal runaway event.

Optional features of the first aspect will now be set out. These are applicable singly or in any combination with any aspect.

The biasing arrangement may be disposed at a periphery of the cell-receiving space. The biasing arrangement may be disposed at a periphery of the first and/or second compression members. The provision of the biasing arrangement at the periphery of the compression members rather than in series with the pouch cells may facilitate a reduction in the overall dimension of the pouch cell enclosure in the cell stack direction.

The pouch cell enclosure may comprise first and second spaced lateral sides. The first and second lateral sides may extend between spaced ends of the pouch cell enclosure. One or both of the ends of the pouch cell enclosure may be at least partly open, providing for access to the tabs (i.e. terminals) of pouch cells when received in the cell-receiving space. The lateral sides and the ends of the enclosure may extend between the spaced apart compression members. In one orientation, for example, the compression members may provide upper and lower walls of the pouch cell enclosure (and the cell stack direction may be substantially vertical). The pouch cell enclosure may have a substantially cuboid shape.

For the avoidance of doubt, the terms “lateral”, “upper” and “lower” are not intended to require the pouch cell enclosure to be used in any particular orientation.

The biasing arrangement may comprise a resilient spring member. The spring member may have a first end connected to the first compression member and a second end connected to the second compression member. The spring member may therefore span the cell-receiving space or may at least partly define a boundary (e.g. a lateral boundary) of the cell-receiving space.

The spring member may extend at least partly along respective peripheries of the first and second compression members. The spring member may extend at least partly along a periphery of the cell-receiving space (and e.g. along respective peripheries of the one or more pouch cells when received therein). For example, when the pouch cell enclosure comprises lateral sides, the spring member may extend partly along a lateral side of the pouch cell enclosure. The spring member may extend for substantially the entirety of a lateral side of the pouch cell enclosure (and may e.g. extend beyond at least one end of the lateral side so as to be longer than the lateral side). The spring member may extend for substantially the entirety of the length of a pouch cell when received in the cell-receiving space.

In this respect, the spring member may define a wall or boundary of the pouch cell enclosure (e.g. aiding in enclosing pouch cell(s) within the cell-receiving space). In such embodiments (whether the wall or boundary extends for an entire side), the spring member may provide dual functionality: providing a protective wall of the pouch cell enclosure while also urging the compression plates towards one another.

The spring member may be configured to flex between an expanded configuration and a contracted configuration. In the contracted configuration, the first and second ends of the spring member may be closer to one another in the cell stack direction than when the spring member is in the expanded configuration. The spring member may be biased towards the contracted configuration. The contracted configuration may, for example, be a natural configuration of the spring member (i.e. may represent the natural shape of the spring member).

Flexing of the spring member may comprise bending of the spring member in a plane that is substantially perpendicular to the direction of extension of the spring member along the periphery of the cell-receiving space (e.g. perpendicular to a direction along the peripheries of the compression members). For, example when the pouch cell enclosure includes lateral sides, the flexing of the spring member may comprise bending of the spring member in a plane that extends perpendicularly to the lateral sides.

Such bending may be promoted by the shape of the spring member. Thus, for example, the spring member may have a thickness dimension that is significantly smaller than length and height dimensions. The height dimension may be taken in a direction between the compression members (the cell stack direction). The width dimension may be taken in a direction along the peripheries of the compression plates. The thickness may be a dimension taken between outer and inner surfaces of the spring member (the outer surface facing away from the cell-receiving space and the inner surface facing towards the cell-receiving space). Thus, the spring member may, for example, be in the form of a sheet material (e.g. a sheet metal).

The spring member may be formed of a thermally conductive material (e.g. copper or aluminium). In this respect, the spring member may be configured to transfer heat away from pouch cells received in the cell-receiving space. In some embodiments, the spring member may be formed of a composite material (e.g. a composite sheet material). The spring member may be formed of a plurality of layers. For example, the composite sheet material may comprise a thermally and/or electrically conductive layer that is combined with a resilient layer. As an example, the spring member may be formed of steel sheet (e.g. spring steel sheet) and may be lined e.g. with a copper layer. In another example, the spring member may be formed of carbon fibre of glass fibre.

In some embodiments, the spring member may be formed of an electrically conductive material.

In some embodiments, the spring member may be formed of a thermally and/or electrically insulating material.

The spring member may comprise a body. The body may be a portion of the spring member that extends between the first and second compression members. The spring member may be configured such that the body has concave profile (in at least the contracted configuration). In some embodiments, the body may have a substantially serpentine profile (or another profile that permits collapsing of the body, such as a corrugated or concertina profile). The body may alternatively be substantially planar (e.g. may have a linear profile). For the avoidance of doubt, the term profile is used here to describe a cross-sectional shape, the cross section being taken along a plane perpendicular to the direction of extension of the spring member along the peripheries of the compression members and/or cell-receiving space.

The body may be configured to flex such that a radius of curvature of the (e.g. concave) profile of the body of the spring member is greater in the expanded configuration than in the contracted configuration. In some embodiments, the body may be expandable from the contracted configuration to a position in which the body is substantially planar (e.g. the body may be substantially planar in the expanded configuration). In some embodiments the body may be expandable from the contracted configuration to a position in which the body is convex towards the cell-receiving space. Accordingly, the body may sit more closely to the compression members and the cell-receiving space when expanded (e.g. in the expanded configuration) than would otherwise be the case if the body were to be concave/curved. This may help minimise the volume of the pouch cell enclosure in use.

The spring member may comprise an arm extending laterally from the body. The arm may engage the first compression member. The arm may define the first end of the spring member.

The arm may be configured to pivot towards and away from the body when the spring member flexes between the contracted and expanded configurations. The arm may be closer to the body in the contracted configuration than in the expanded configuration. The arm may be biased towards the contracted configuration.

An arm extension angle α may be defined between the body and the arm (of the spring member). For the avoidance of doubt, the arm extension angle α is an internal angle (not the external angle) between the arm and the body. The arm may be configured to bend relative to the body so that the arm extension angle α is larger in the expanded configuration than in the contracted configuration. As above, the arm may be biased towards the contracted configuration. The arm extension angle α may be an acute angle (e.g. in one or both of the contracted and expanded configurations). In the expanded configuration, the arm extension angle α may be approximately 90 degrees (e.g. may be between 70 and 120 degrees or between 80 and 100 degrees).

In some embodiments, the arm may be a first arm and the spring member may comprise a second arm extending laterally from the body. The second arm may engage the second compression member. The second arm may define the second end of the spring member. The second arm may function in the manner described with respect to the first arm. Thus, the second arm may be configured to pivot towards and away from the body when the spring member flexes between the contracted and expanded configurations. The second arm may be closer to the body in the contracted configuration than in the expanded configuration.

The second arm may function in the manner described above with respect to the first arm. A second arm extension angle β may be defined between the body and the second arm. The second arm may be configured to bend relative to the body so that the second arm extension angle β is larger in the expanded configuration than in the contracted configuration. The second arm may be biased towards the contracted configuration. The second arm extension angle β may be an acute angle (e.g. in one or both of the contracted and expanded configurations). In the expanded configuration, the arm extension angle α may be approximately 90 degrees.

The spring member may have a substantially C-shaped profile (e.g. the body providing the spine of the “C”, and the arms providing the two lateral projections). In this way, the spring member may be configured to wrap around a side of the pouch cell enclosure (e.g. so as to define a lateral wall of the enclosure).

At least one of the first and second arms may engage the respective compression plate and an engagement region that is inward of a lateral edge of the compression plate. The engagement region may, for example, be a distance from the lateral edge that is between 20% and 40% of a width of the compression plate (e.g. about a third of the way across the compression plate in the lateral direction).

In embodiments in which the second arm is not present, the second end of the spring member may instead be engaged with, or may be integral with, the second compression member.

The pouch cell enclosure may comprise a strut (e.g. plate) that extends from one lateral side of the enclosure to another lateral side of the enclosure across the cell-receiving space. The strut may be arranged such that, in use, it is received between two pouch cells in a stack of pouch cells received in the cell-receiving space. The strut may be substantially parallel to the first and second compression members. The body of the spring member may comprise a strut engagement portion for retaining the strut. The strut engagement portion may be a recess for engagement with a corresponding protrusion or edge of the strut.

The spring member may comprise one or more shock absorbing elements (e.g. integrally formed as part of the spring member). For example, the spring member may comprise one or more tabs projecting out of plane from the spring member. The one or more tabs may project from the body of the spring member (e.g. laterally outwardly from the body).

The spring member may comprise one or more resilient protrusions for engaging a portion of a device in which the enclosure may be received. The one or more resilient protrusions may, for example, project outwards from the first or second arm. The one or more resilient protrusions may be integrally formed as part of the spring member. Each of the one or more resilient protrusions may, for example, be in the form of a lance bridge feature.

In some embodiments, the enclosure may comprise a plurality of spring members (i.e. each as described above). For example, the enclosure may comprise a plurality of spring members spaced along the periphery (e.g. a lateral side) of the pouch cell enclosure. When the enclosure includes opposite lateral sides, the enclosure may include two spring members, one provided on each of the lateral sides (or each lateral side may be provided with a plurality of spring members spaced therealong).

In some embodiments, the spring member may be configured to flex between the expanded and contracted configurations by bending in a plane that is substantially parallel to the direction of extension of the spring member along the periphery of the cell-receiving space (e.g. parallel to the peripheries of the compression members). For, example when the pouch cell enclosure includes lateral sides, the flexing of the spring member may comprise bending of the spring member in a plane that is parallel to the lateral sides.

The spring member may comprise a flexible structure extending between the first and second ends of the spring member. The flexible structure may be collapsible in the stack direction to provide movement of the spring member between the expanded and contracted positions.

The flexible structure may be provided with apertures (or openings) therethrough, arranged to promote bending of the flexible structure as described above.

The flexible structure may comprise a first elongate member extending obliquely from the first end of the spring member towards the second compression plate. The spring structure may further comprise a second elongate member extending obliquely from the second end of the spring member towards the first compression plate. The first and second elongate members may join intermediate the first and second ends (and intermediate the first and second compression members) to form an elbow that flexes in a hinged manner to permit movement of the flexible structure (and thus spring member) between the contracted and expanded configurations.

The spring member may comprise two such flexible structures. The two flexible structures may be arranged such that they partly overlap. The two flexible structures may be reversed in orientation with respect to one another (i.e. one may be a mirror image of the other). In this way, the elbows of the two flexible structures may point in opposite directions along the periphery of the cell-receiving space.

Alternatively, the flexible structure may be in the form of a lattice. That is, the flexible structure may comprise a plurality of interconnected elongate elements that extend obliquely between the first and second ends of the spring member. The elongate element may, for example, be arranged to form a plurality of connected triangular units.

In further embodiments, the flexible structure may, for example, comprise a plurality of spaced apart serpentine elements extending between the first and second ends of the spring member.

As may be appreciated, in each of the above-described embodiments, a plurality of spring members (i.e. each as described above) may be provided. For example, the plurality of spring members may be spaced along a periphery of the pouch cell enclosure (e.g. spaced along respective peripheries of the first and second compression members). Where the pouch cell enclosure (and e.g. each compression member) has opposite lateral sides, at least one spring member may be provided on each lateral side. Each lateral side may comprise a spring member that extends for substantially the entire length of the lateral side. In this way, the pouch cell enclosure may comprise two spring members forming opposite lateral side walls thereof.

In some embodiments, the biasing arrangement may be configured to provide a substantially constant restoring force as it is expanded (e.g. by expansion of the pouch cells). As may be appreciated, this may translate to the provision of a substantially constant amount of compression being applied to pouch cells received in the cell-receiving space regardless of the state of expansion of the pouch cells.

In other words, the biasing arrangement may be configured to move between expanded and contracted configurations, with the biasing arrangement being biased towards the contracted configuration (in which the first and second compression members are closer together in the stack direction than in the expanded configuration). Such a biasing arrangement may be configured to provide a substantially constant restoring force as it is moved from the contracted configuration to the expanded configuration.

The biasing arrangement may comprise a spring (e.g. a leaf spring or compression spring) connected to one of the first and second compression members and a cam surface connected to the other of the first and second compression members. A portion of the spring may move across the cam surface as the biasing arrangement is moved from the contracted configuration to the expanded configuration.

The biasing arrangement may comprise a spring (e.g. a leaf spring or compression spring) connected to one of the first and second compression members and a pivotably mounted linkage that is connected to the other of the first and second compression members. The spring may be engaged by the linkage as the biasing arrangement is moved from the contracted configuration to the expanded configuration so as to be bent and/or compressed by pivoting of the linkage. In one example, the biasing arrangement may comprise first and second portions. The first portion may extend from the first compression member towards the second compression member. The first portion may have a proximal end at the first compression member and an opposite distal end (i.e. distal from the first compression member). The second portion may extend from the second compression member towards the first compression member. The second portion may have a proximal end at the second compression member and an opposite distal end (i.e. distal from the second compression member). The biasing arrangement may comprise a spring element arranged between the distal end of the first portion and the distal end of the second portion. The spring element may be biased to urge the distal ends of the first and second portions away from one another in the cell stack direction.

The spring element may be a leaf spring. The spring element may have a first end at (e.g. mounted to or integral with) the distal end of the second portion. The spring element may extend from the first end to a free second end in contact with the distal end of the first portion. The distal end of the first portion may comprise a cam surface. The free second end of the spring element may move across the cam surface as the biasing arrangement is moved from the contracted configuration to the expanded configuration. Such movement may cause deflection of the spring element. For example, the spring element (e.g. leaf spring) may be caused to hinge about the first end of the spring element. In this way, the second end of the spring element may be deflected in a direction away from the second portion (and/or the first portion).

The cam surface may be convex. The cam surface may be shaped such that as the biasing arrangement is moved from the contracted configuration to the expanded configuration the deflection of the leaf spring caused by the cam surface provides a substantially constant restoring force.

The spring element may be a first spring element and the biasing arrangement may comprise a second spring element having a first end mounted to the distal end of the second portion and a second free end in contact with the distal end of the first portion. The first and second spring elements may be provided on opposite sides of the first and/or second portions. The cam surface may be a first cam surface and a second cam surface may be provided with which the free second end of the second spring element contacts.

The first and second portions and the spring member(s) may define a biasing device of the biasing arrangement. As may be appreciated, the biasing arrangement may comprise a plurality of such biasing devices, which may be spaced along a periphery of the cell-receiving space. In some embodiments, when the pouch cell enclosure comprises lateral sides, the biasing devices may be spaced along one or both lateral sides (i.e. connecting respective lateral sides of the compression members).

In some embodiments, the biasing arrangement may comprise an elastic member arranged to urge the first and second compression members towards one another. In some embodiments, as will now be described, the second compression member may form a portion of the elastic member. The elastic member may, for example, comprise a laterally-extending portion that extends laterally across an interior of the pouch cell enclosure and this laterally-extending portion may define the second compression member. The elastic member may comprise end portions (either side of the laterally-extending portion) that connect the laterally-extending portion to the first compression member. The cell-receiving space may be defined between the laterally-extending portion and the first compression member.

The pouch cell enclosure may comprise lateral sidewalls (to which the end portions may be fixed). Each sidewall may comprise an aperture through which the elastic member extends. Each aperture may be sized to allow movement of the laterally-extending portion of the elastic member in the cell-stack direction.

In any of the above-described embodiments, at least one of the first and second walls may comprise a fastener for mounting an external component to the first or second wall. The fastener may comprise a head pressed into the first wall such that the first or second wall is deformed around the fastener to retain the fastener in the first or second wall. The fastener may comprise a shaft extending from the head so as to project from, and beyond, the outer surface of the first or second wall. The shaft or head of the fastener may comprise (e.g. radially or axially extending) teeth. Deformed material may be received between the teeth. The shaft or head of the fastener may comprise a recess extending circumferentially (e.g. fully) around the shaft or head. Deformed material may be received in the recess. The shaft of the fastener may be threaded. The head of the fastener may be fully received within the first or second wall (i.e. may not project therefrom).

In a second aspect, there is disclosed battery comprising:
one or more pouch cells; and
a pouch cell enclosure comprising:
first and second compression members spaced apart in a cell stack direction so as to define a cell-receiving space therebetween in which the one or more pouch cells are received, the first and second compression members being moveable relative to one another in the cell stack direction; and
a biasing arrangement connecting the first and second compression members and configured to urge the first and second compression members towards one another.

The battery of the second aspect is advantageous for the same reasons as discussed above with respect to the first aspect.

Optional features of the second aspect will now be set out. These are applicable singly or in any combination with any aspect.

The pouch cell enclosure of the second aspect may be as described above with respect to the first aspect and may include one or more of the optional features described above with respect to the first aspect.

Each pouch cell may have opposite first and second major faces, which may respectively face towards the first and second compression members. The major faces of each pouch cell may be substantially perpendicular to the cell stack direction. The layers of an internal layered structure of each pouch cell may be substantially parallel to the major faces of the pouch cell.

Each pouch cell may comprise opposite lateral sides (e.g. aligned with the lateral sides of the enclosure) and may comprise opposite ends. Each pouch cell may comprise at least two terminals, which may be at the same end or at opposite ends of the pouch cell.

In a third aspect there is disclosed an appliance comprising the battery of the second aspect.

Optional features of the third aspect will now be set out. These are applicable singly or in any combination with any aspect.

The appliance may be, for example, a vacuum cleaner.

The appliance may comprise an appliance housing, which may house the battery.

### BRIEF DESCRIPTION OF THE DRAWINGS

FIG. 1A is a perspective view of a pouch cell enclosure according to a first embodiment;

FIG. 1B is a perspective view of a spring member of the pouch cell enclosure of FIG. 1A;

FIG. 1C is a front view of the spring member of FIG. 1B;

FIG. 2 is a section view of a pouch cell enclosure according to a second embodiment;

FIGS. 3A and 3B are section views of a pouch cell enclosure according to a third embodiment;

FIG. 4 is a perspective view of a spring member for a pouch cell enclosure according to a fourth embodiment;

FIG. 5 is a section view of part of a pouch cell enclosure according to a fifth embodiment;

FIG. 6 is a side view of a pouch cell enclosure according to a sixth embodiment;

FIG. 7 is a perspective view of a spring member for a pouch cell enclosure according to a seventh embodiment;

FIG. 8 is a perspective view of a spring member for a pouch cell enclosure according to an eighth embodiment;

FIG. 9A is a perspective view of a pouch cell enclosure according to a ninth embodiment;

FIG. 9B is a section view of a biasing device of the pouch cell enclosure of FIG. 9A;

FIG. 10 is a perspective view of a biasing device of a pouch cell enclosure according to a tenth embodiment;

FIGS. 11A, 11B, 11C and 11D provide variations of the biasing device according to an eleventh embodiment;

FIG. 12A is a section view of a pouch cell enclosure according to a twelfth embodiment; and

FIG. 12B is a side view of the pouch cell enclosure of FIG. 12A.

### DETAILED DESCRIPTION

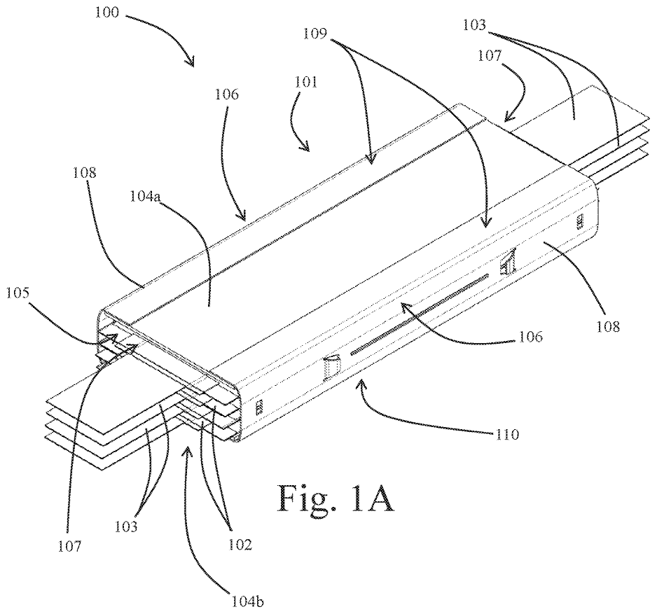

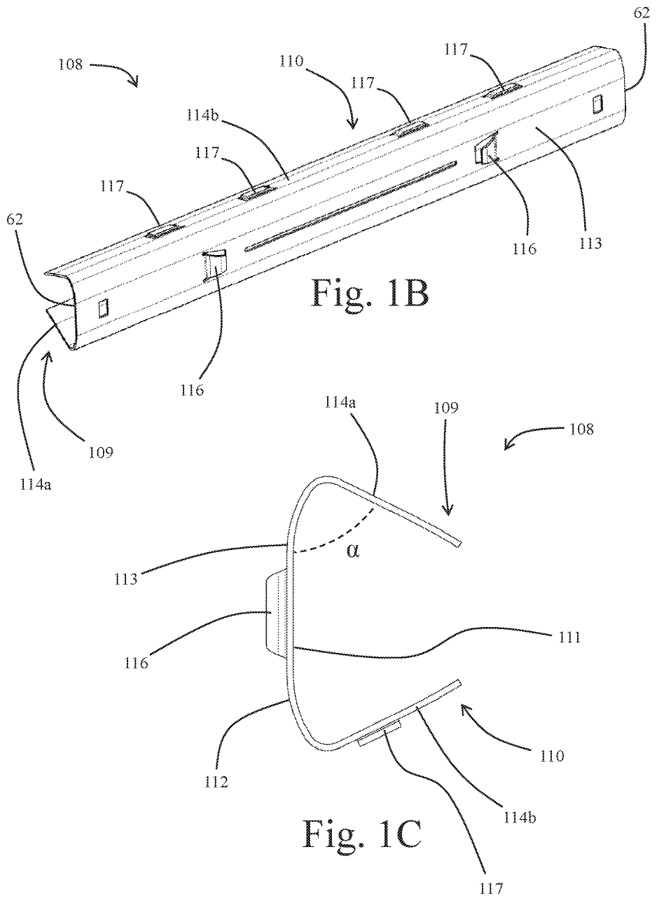

FIG. 1A depicts a battery 100 that includes a pouch cell enclosure 101 and a plurality of (in this case four) pouch cells 102 stacked within the pouch cell enclosure 101. Each pouch cell 102 includes an internal layered structure (which provides the function of the battery) housed with a flexible pouch, and two tabs 103 that act as terminals so as to allow electrical connection to the internal layered structure. In the presently illustrated embodiment, each pouch cell 102 has a generally rectangular shape, so as to include two opposite lateral sides extending between two opposite ends. The two terminals 103 of each pouch cell 102 are provided at the opposite ends of the pouch cell 102. Each pouch cell 102 also as two opposite (substantially rectangular) major faces, and the pouch cells 102 are stacked so that their major faces are in contact.

The pouch cell enclosure 101 includes first 104a and second 104b substantially parallel compression members (only one of which is visible) spaced apart in a cell stack direction (vertical as illustrated) so as to define a cell-receiving space 105 therebetween for receipt of the pouch cells 102. Each compression member 104a, 104b is a substantially rectangular and planar plate, so as to have two opposite lateral sides 106 that extend between two opposite ends 107 of the compression member 104a, 104b. The cell stack direction extends in a direction that is normal to each of the first 104a and second 104b compression members. As illustrated, the first compression member 104a provides an upper wall of the pouch cell enclosure 101 and the second compression member 104b provides a lower wall of the pouch cell enclosure 101 (it should be appreciated, however, that the pouch cell enclosure 101 may be used in any orientation).

The pouch cells 102 are stacked within the cell-receiving space 105 so as to be held between the first 104a and second 104b compression members. An inner surface of the first compression member 104a contacts an uppermost pouch cell 102 of the stack of pouch cells 102, and an inner surface of the second compression member 104b contacts a lowermost pouch cell 102 of the stack of pouch cells 102.

The first 104a and second 104b compression members are moveable relative to one another in the cell stack direction. In this way, the first 104a and second 104b compression members are able to move as the pouch cells 102 expand and contract during use. As has been explained further above, however, it can also be beneficial to maintain some compression of the pouch cells 102 throughout such expansion and contraction.

To provide this compressive force, the pouch cell enclosure 101 further comprises a biasing arrangement in the form of two spring members 108, connecting the first 104a and second 104b compression members. Each spring member 108 comprises a first end 109 that engages the first compression member 104a and a second end 110 that engages the second compression member 104b. The spring members 108 are configured to urge the first 104a and second 104b compression members towards one another (i.e. in the cell stack direction) to apply a compressive force to the pouch cells 102 in the cell-receiving space 105.

As should be apparent from FIG. 1A, each spring member 108 extends along a periphery of the cell-receiving space 105, and peripheries of the first 104a and second 104b compression members. In particular, each spring member 108 extends substantially entirely along the respective lateral sides 106 of the first 104a and second 104b compression members (although in other embodiments, each spring member 108 may extend only partway along a respective lateral side 106). As a result, the pouch cell enclosure 101 has a substantially cuboid shape, with each spring member 108 forming a lateral side of the enclosure 101 (i.e. providing side walls of the enclosure 101).

In effect, the spring members 108 thus provide dual functionality: they provide the biasing force that urges the compression members 104a, 104b together, while also acting as walls to protect the pouch cells 102 held within the cell-receiving space 105. Ultimately, this can reduce the volume of the battery 100 (i.e. increasing energy density of the battery 100).

FIGS. 1B and 1C illustrate one of the spring members 108 of the battery 100. As may be appreciated, both spring members 108 of the battery 100 are identical but are arranged in reversed orientation. FIG. 1B shows the underside of the spring member 108 (i.e. the spring member 108 is oriented with the second arm 114b provided on top and the first arm 114a on the bottom).

The spring member 108 is configured to flex between an expanded configuration (as is shown in FIG. 1A) and a contracted configuration (as is shown in FIGS. 1B and 1C). In the contracted configuration, the first 109 and second ends 110 of the spring member 108 are closer to one another in the cell stack direction than when the spring member 108 is in the expanded configuration. The spring member 108 is biased towards the contracted configuration (i.e. the contracted configuration is the natural configuration of the spring member 108).

The flexing of the spring member 108 is facilitated by its shape. The spring member 108 is formed of sheet metal, such that a thickness dimension (between inner 111 and outer 112 surfaces) of the spring member 108 is much smaller than height and length dimensions of the spring member 108. The spring member 108 also has a substantially uniform cross-sectional shape along its length.

The spring member 108 includes a body 113, and first 114a and second 114b arms that extend laterally from the body 113 to respectively engage the first 104a and second 104b compression members (in particular, outer surfaces of the first 104a and second 104b compression members). In this way, the spring member 108 has a C-shaped profile and acts like a clip that wraps around a side of the battery 100 (as per FIG. 1A). The body 113 and arms 114a, 114b flex in use as the pouch cells 102 expand and contract causing the spring member 108 to move between the expanded and contracted configurations.

In particular, each arm 114a, 114b pivots (or hinges) towards and away from the body 113 when the spring member 108 moves between the contracted and expanded configurations. In this way, each arm 114a, 114b is closer to the body 113 when the spring member 108 is in the contracted configuration. In other words, an arm extension angle a defined between the body 113 and each arm 114a, 114b is larger in the expanded configuration than in the contracted configuration.

The body 113 of the spring member 108 also flexes in use. In particular, the body 113 flexes between having a substantially concave profile (as shown in FIG. 1C) in the contracted position, to having substantially linear profile (as per FIG. 1A). In other words, the radius of curvature of the (e.g. concave) profile of the body 113 of the spring member 108 is greater in the expanded configuration than in the contracted configuration. Accordingly, the body 113 can sit more closely to the pouch cells 102 when expanded.

As should be apparent from the figures, the flexing of the spring member 108 (including flexing of the arms 114a, 114b and the body 113) comprises bending in a plane that is substantially perpendicular to the length direction of the spring member 108 (i.e. a plane that extends in a direction laterally across the battery 100). Thus, the bending generally includes movement of the body 113 of the spring member 108 towards and away from the pouch cells 102 in the cell-receiving space 105.

Flexing of each spring member 108 in this way ensures that the pouch cells 102 remain compressed as they expand and contract in use. This can prevent, for example, delamination of the internal layers of each pouch cells 102. Each spring member 108 also includes further features that help to protect the pouch cells 102. For example, each spring member 108 includes two shock absorbing tabs 116 that project laterally outwardly from the body 113 of the spring member 108 to act as shock absorbers for lateral impact. Each tab 116 is formed as a cut-out from the sheet metal of the respective spring member 108 that has been bent out of plane. Each spring member 108 also includes four outwardly projecting resilient protrusions 117 on the second arm 114b thereof, each protrusion 117 formed as a bridge lance feature (i.e. an out of plane bridge connected at both ends to the second arm 114b). As may be appreciated, such protrusions 117 may additionally or alternatively be provided on the first arm 114a. These protrusions 117 engage a housing of a device in which the battery 100 is received in use to help retain the battery 100 in position within the housing.

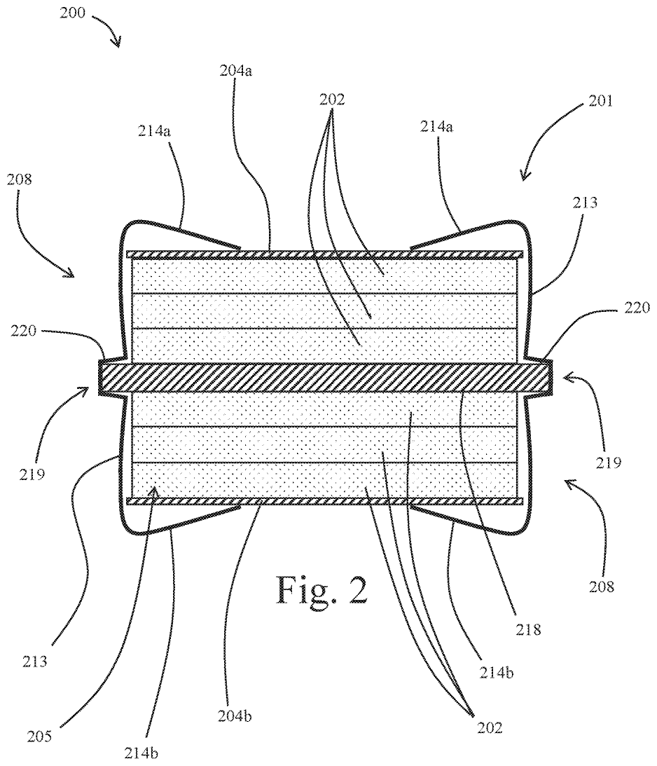

Although not illustrated, it should be appreciated that each spring member 108 may further include shock absorbing tabs (or other shock absorbing feature) that bend to absorb shock loading that is applied in a direction along a length of the spring member 108, Such shock absorbing tabs could, for example, extend obliquely from side edges 62 of the spring member 108. FIG. 2 shows a battery 200 that is variation of the battery 100 described above (and shown in FIGS. 1A, 1B and 1C). Similar reference numerals have been used for corresponding features. The illustrated battery 200 includes a strut 218 that extends across the cell-receiving space 205 between the first 214a and second 214b compression members. The strut 218 is a plate that is substantially parallel to the first 214a and second 214b compression members and that is disposed between two pouch cells 202 of the stack of pouch cells 202. The strut 218 is therefore in contact (but may be in indirect engagement via e.g. an adhesive layer) with two of the pouch cells 202 (and, in particular, is in contact with substantially the entirety of a respective major face of each of those pouch cells 202).

As is apparent from FIG. 2, lateral sides 219 of the strut engage each of the two spring members 208. To enable this, each spring member 208 comprises an elongate strut-receiving recess 220 (i.e. a groove) extending in a direction along a length of the spring member 208 (into the page as illustrated). The lateral sides 219 of the strut 218 are received in the strut-receiving recess 220 of each spring member 208. The strut 218 aids in supporting the pouch cells 202 within the cell-receiving space 205.

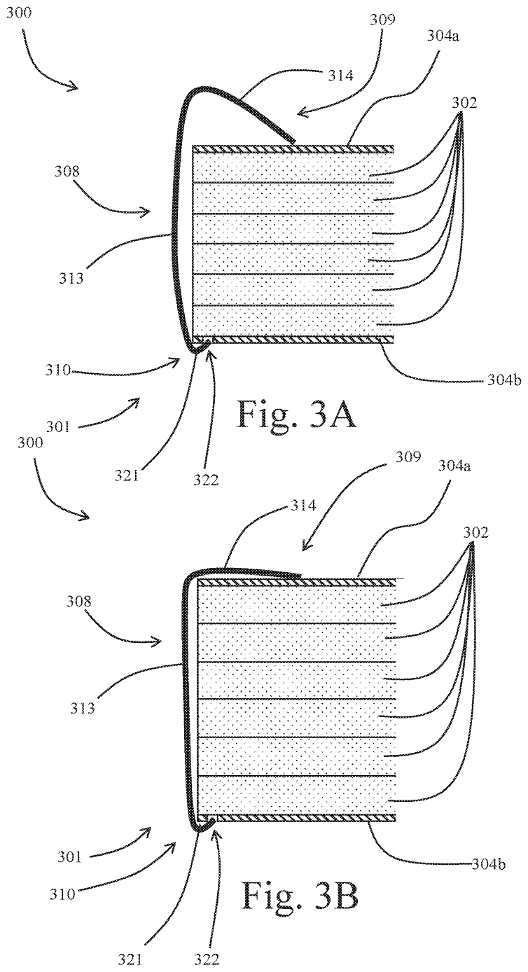

FIGS. 3A and 3B illustrate part of battery 300 that is a further variation of the embodiment shown in FIGS. 1A, 1B and 1C. Again, similar reference numerals have been used to identify similar features. FIG. 3A shows the battery 300 in a compressed or contracted configuration and FIG. 3B shows the battery 300 in an expanded configuration (in which the pouch cells 302 have expanded).

In this variation of the battery 300, each spring member 308 (only one of which is shown) includes a single arm 314 extending laterally from the body 313. Instead of providing a second arm, the body 313 is provided with a hook-shaped engagement member 321 that defines the second end 310 of the spring member 308 and that that engages a recess 322 of the second compression member 304b. As may be appreciated, in other embodiments the second compression member 304b and spring member 308 may be integrally formed (i.e. may be a unitary piece).

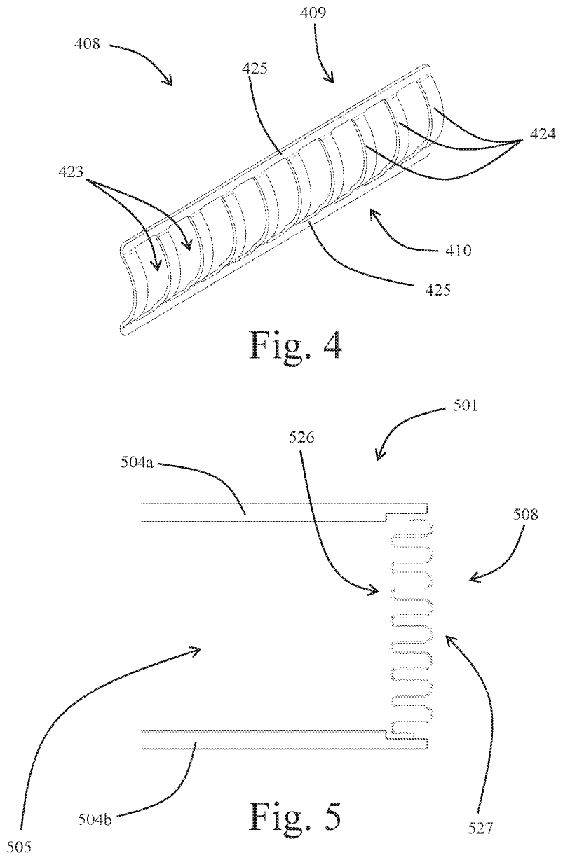

FIG. 4 illustrates an embodiment in which the spring member 408 is, again, formed of sheet metal, and bends in a plane perpendicular to the length of the spring member 408 (i.e. a laterally extending plane), but that includes apertures 423 to promote such bending. In particular, the spring member 408 includes a plurality of apertures 423 spaced along a length thereof, which form a plurality of elongate (and resilient) portions 424 connecting first 409 and second 410 ends of the spring member 408, which are defined by elongate bars 425 extending in the length direction (i.e. extending along lateral sides of the compression members when connected thereto). Each elongate portion 424 is curved between the first 409 and second 410 ends to further promote bending thereof. Although not illustrated, it should be appreciated that the first 409 and second 410 ends of the spring member 408 may connect to first and second compression member via various engagement means (including e.g. arms as described above).

The spring member 508 of FIG. 5 (forming part of a pouch cell enclosure 501) is, instead, able to bend by way of its serpentine profile. The spring member 508, which connects first 514a and second 514b compression members, includes a plurality of curves alternating in direction so as to form a serpentine profile that promotes bending (i.e. the curves allowing the spring member 508 to collapse and expand in the cell stack direction). As should be apparent from the figure, the curves on the inner side 526 of the spring member 508 (closer to the cell-receiving space 505) have a smaller radius of curvature than those on the outer side 527 of the spring member 508. This can provide more (vertical) space on the inner side 526 of the spring member 508 for receipt of portions of the pouch cells (when received in the cell-receiving space 505), which may allow a reduction in overall volume of the pouch cell enclosure 501.

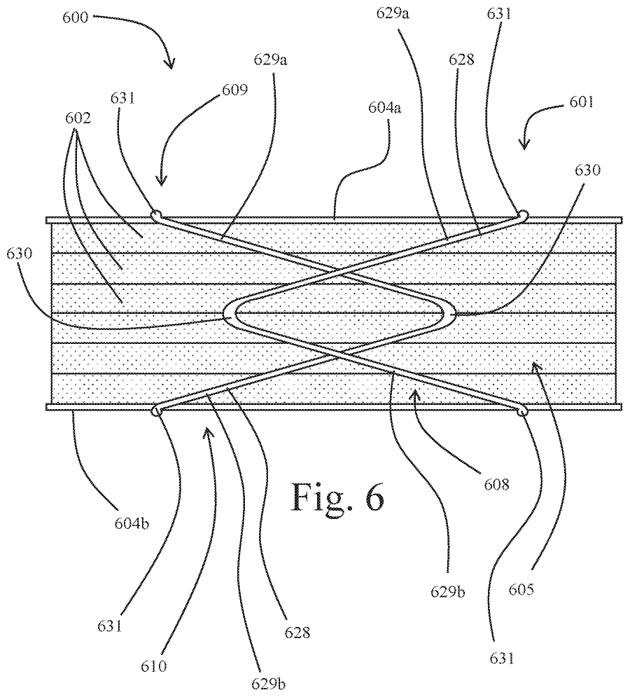

The battery 600 of FIG. 6 differs from those previously described in that each spring member 608 (the battery 600 includes two spring members 608 on opposite lateral sides thereof, but only one is shown) is configured to flex between the expanded and contracted configurations by bending in a plane that is substantially parallel to the direction of extension of the spring member 608 along the periphery of the cell-receiving space 605. In other words, each spring member 608 bends in a plane that extends along a lateral side of the battery 600.

Each spring member 608 includes two flexible structures 628 that each extend between the first 609 and second 610 ends of the spring member 608 and that are collapsible in the stack direction to provide movement of the spring member 608 between the expanded and contracted positions. Each flexible structure 628 includes first 629a and second 629b elongate members. Each first elongate member 629a extends obliquely from the first end 609 of the respective spring member 608 towards the second compression plate 604b. The second elongate member 629b extends obliquely from the second end 610 of the spring member 608 towards the first compression plate 604a. The first 629a and second 629b elongate members join intermediate the first 609 and second 610 ends (and intermediate the first 604a and second 604b compression members) to form an elbow 630 that flexes in a hinged manner to permit movement of each flexible structure 628 between the contracted and expanded configurations.

The two flexible structures 628 of each spring member 608 are arranged in a reversed manner such that they overlap and their respective elbows 630 point in opposite directions along the lateral sides of the battery 600. In this way, the first elongate members 629a of the two flexible structures 628 extend across one another and the second elongate members 629b of the two flexible structures 628 extend across one another.

Each flexible structure 628, at each end thereof, may comprise a laterally extending connecting member 631 (extending into the page as illustrated) that extends laterally across the outer surface of a respective compression member 604a, 604b. Each connecting member 631 may connect a respective flexible structure 628 to a flexible structure 628 provided on the opposite lateral side of the battery 600 (i.e. forming part of the other of the two spring members 608). In this way, the spring members 608 may form a cage that extends about the enclosure 601 and provides compression of the pouch cells 602 by urging the compression members 604a, 604b towards one another.

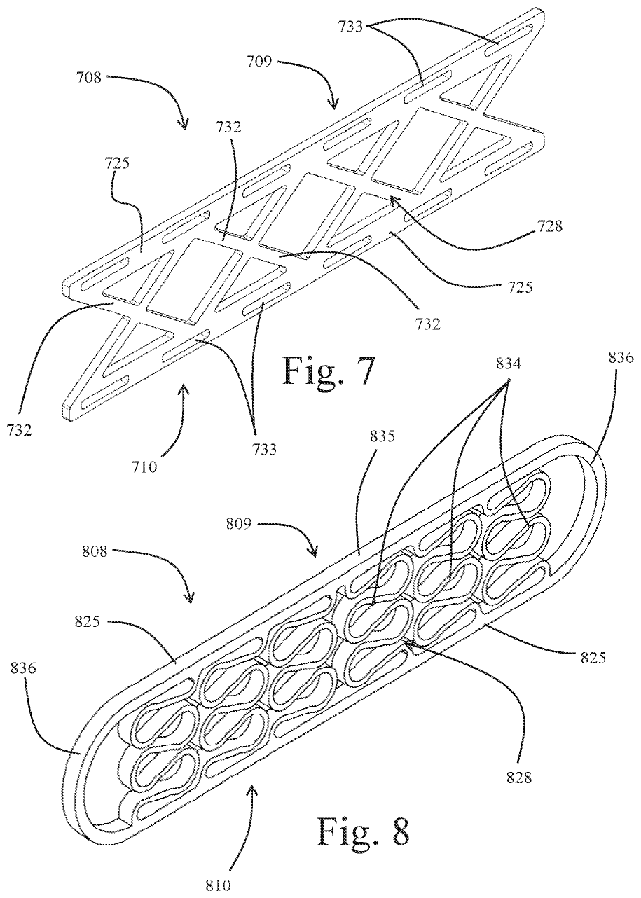

FIG. 7 illustrates a further embodiment in which the spring member 708 is configured to bend in a plane that is parallel to the length direction of the battery. In this case, the flexible structure 728 of the spring member 708 (which is formed as a unitary piece) comprises a plurality of interconnected elongate elements 732 (only some of which are labelled for clarity) that extend obliquely between the first 709 and second 710 ends of the spring member 708. The elongate elements 732 form a plurality of connected triangular units such that the flexible structure 728 has a lattice formation. Elongate bars 725 extend in the lengthwise direction of the spring member 708 at the first 709 and second 710 ends (the flexible structure 728 extending between these elongate bars 725). Elongate slots 733 are spaced along each bar 725, which allows for connection of the spring member 708 to compression plates in use.

FIG. 8 illustrates yet another embodiment in which the spring member 808 is configured to bend in a plane that is parallel to the length direction of the battery. The spring member, which is formed as a unitary piece 808, of this embodiment includes a flexible structure 828 provided by a plurality of spaced apart serpentine elements 834 extending between the first 809 and second 810 ends of the spring member 808. These bend to permit expansion and contraction of the spring member 808. The serpentine elements 834 are connected within an obround-shaped peripheral element 835. The obround element 835 includes elongate bars 825 forming the first 809 and second 810 ends of the spring member 808 and oppositely arranged arcuate (semi-circular) connecting elements 836 that connect the elongate bars 825.

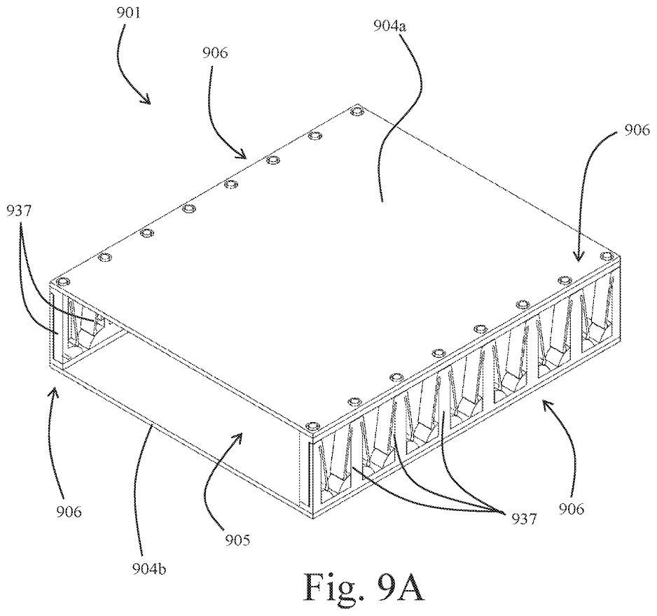

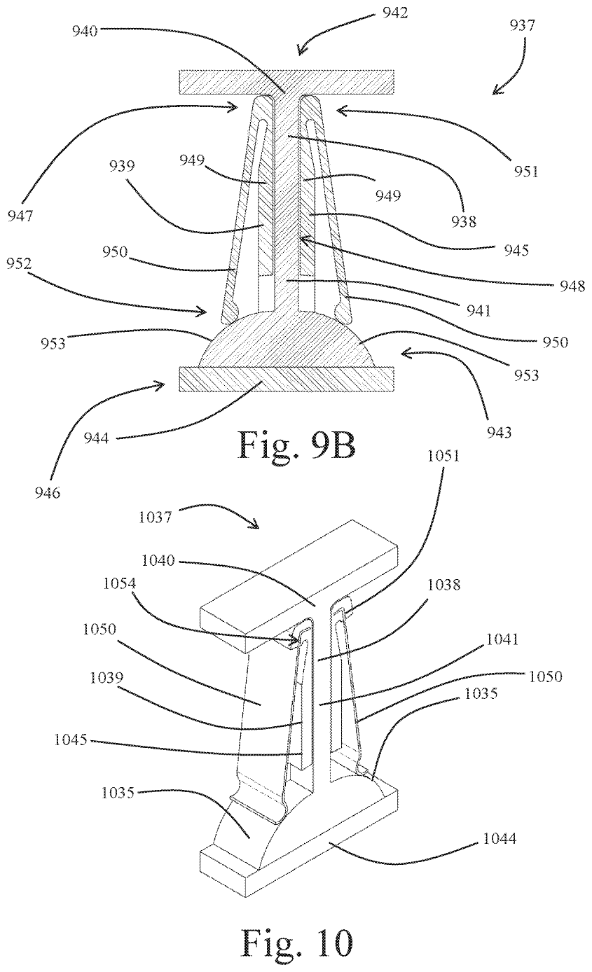

FIGS. 9A and 9B illustrate a further embodiment in which the pouch cell enclosure 901 comprises a biasing arrangement configured to provide a substantially constant restoring force as it is expanded (e.g. by expansion of the pouch cells). As may be appreciated, this can give rise to the provision of a substantially constant amount of compression being applied to the pouch cells regardless of the state of expansion of the pouch cells.

The biasing arrangement includes a plurality of biasing devices 937. The biasing devices 937 are spaced apart along lateral sides 906 of the compression members 904a, 904b, such that each biasing device 937 extends between the first 904a and second 904b compression members. A single biasing device 937 is shown in FIGS. 9B and 9C, which will be described below. While only one such biasing device 937 will be described, it should be appreciated that each biasing device 937 is the same, except for those on the ends of each row of biasing devices 937 (the end biasing devices 937 being modified so as to be half of a typical biasing device 937—this is apparent from FIG. 9A).

Each biasing device 937 includes first 938 and second 939 portions. The first portion 938 includes a base 940 secured to the first compression member 904a and a stem 941 that extends from the first compression member 904a towards the second compression member 904b. The first portion 938 therefore has a proximal end 942 at the first compression member 904a (defined by the base 940) and an opposite distal end 943 (i.e. distal from the first compression member 904a), forming part of the stem 941.

The second portion 939 also includes a base 944 secured to the second compression member 904b and a stem 945. In this case, the stem 945 extends from the second compression member 904b towards the first compression member 904a. The second portion 939 therefore has a proximal end 946 (defined by the base 944) at the second compression member 904b and an opposite distal end 947 (i.e. distal from the second compression member 904b) forming part of the stem 945.

The stem 945 of the second portion 939 comprises a recess 948 (defined between two spaced apart walls 949 of the stem) along its length within which the stem 941 of the first portion 938 is slidably received. As may be appreciated, in other embodiments the first portion 938 may instead include the described recess.

The biasing device 937 further includes two spring elements 950, each in the form of a leaf spring, that are arranged either side of the first 938 and second 939 portions (i.e. the first 938 and second 939 portions extend between the two spring elements 950). Each spring element 950 extends between the distal end 943 of the first portion 938 and the distal end 947 of the second portion 939, and (as will be described further) is biased to urge the distal ends 943, 947 of the first 938 and second 939 portions away from one another in the cell stack direction.

In particular, each spring element 950 includes a first end 951 that is integral with the distal end 947 of the second portion 939, and extends from the first end 951 to a free second end 952 in contact with the distal end 943 of the first portion 938. The second end 952 of each spring element 950 is bulbous and rounded. The distal end 943 of the first portion 938 includes two convex (arcuate) cam surfaces 953 (facing back towards the proximal end 942 of the first portion 938) across which the free second end 952 of each spring element 950 moves as the biasing device 937 is moved from the contracted configuration to the expanded configuration. To allow movement between the first 938 and second 939 portions, the spaced apart walls of the second portion 939 terminate (at their proximal ends) at a location that is spaced from the convex cam surfaces 953.

The movement of the spring elements 950 across the cam surfaces 953 causes deflection of each spring element 950. As the compression members 904a, 904b are moved away from one another (by expansion of pouch cells in the cell-receiving space 905) the second ends 952 of the two spring elements 950 are forced apart by way of their contact with the convex cam surfaces 953. The deflection of the spring elements 950 is mostly in the form of each spring element 950 hinging at its first end 951 (where it integrally connects to the second portion 939 via a bend).

The nature of the deflection of each spring element 950 is such that the magnitude of the deflection changes in a non-linear manner (due to the convex shape of each cam surface 953) as the compression members 904a, 904b (and thus first 938 and second 939 portions) move apart in the cell stack direction. In particular, as the compression members 904a, 904b move apart, the rate of deflection (i.e. deflection per expansion distance) of each spring member 950 decreases. The non-linearity of the relationship between the deflection and amount of expansion counteracts the non-linear nature of the restoring force of each spring element 950, which is a result of its material properties. That is, typically, the nature of a spring element 950 (such as a leaf spring) is such that the further it is deflected, the greater the restoring force, but in the present embodiment this is counteracted by the reduced deflection of each spring element 950 as the compression members 904a, 904b are moved away from one another.

Accordingly, the result is a biasing device 937 that provides a substantially constant force urging the compression members 904a, 904b towards one another, throughout the expansion of the pouch cell enclosure 901 between the contracted and expanded configurations. In this way, a substantially constant compressive force may be applied to pouch cells received in the cell-receiving space 905.

FIG. 10 illustrates a biasing device 1037 that is a variation of that shown in FIG. 9B. In this variation, each spring element 1050 is a separate element mounted to the stem 1045 of the second portion 1039. In particular, the first end 1051 of each spring element 1050, which includes a bend, is received in a correspondingly curved slot 1054 of the stem 1045 of the second portion 1039. Each spring element 1050 may, for example, be formed of steel.

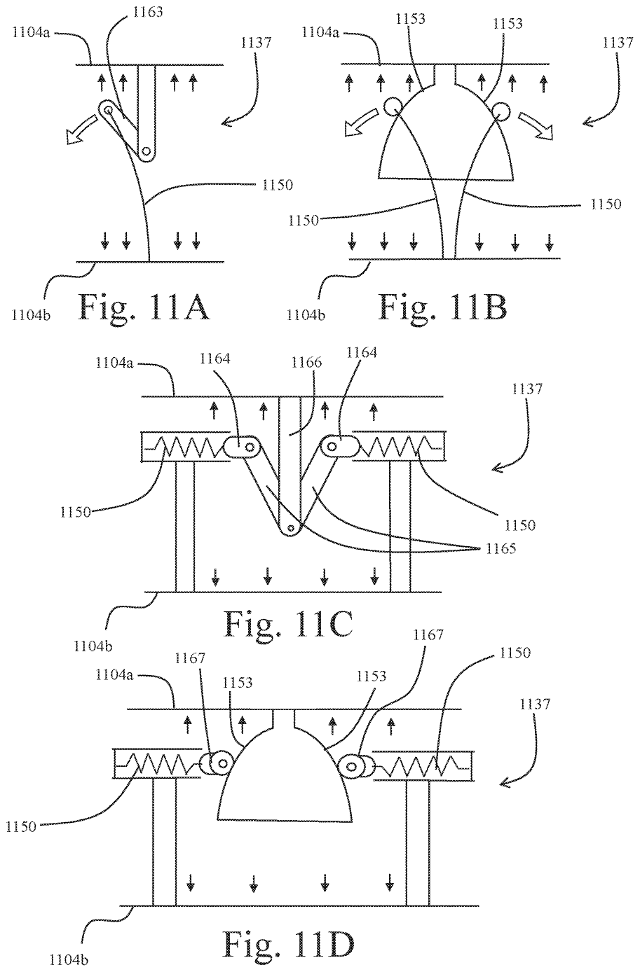

FIGS. 11A, 11B, 11C and 11D show variations of the biasing device 937 of FIG. 9. Further variations (not illustrated) that achieve a similar (or the same function) will be apparent to the skilled person. Each of the illustrated variations provides a substantially constant restoring force as it is expanded (e.g. by expansion of the pouch cells). It should therefore be appreciated that each of the illustrated variations could provide a replacement to the biasing device 937 illustrated in FIG. 9 (while providing substantially the same function).

For brevity, the same reference numerals have been used for the same features in each of FIGS. 11A-11D.

Each variation includes a biasing device 1137 that connects first 1104a and second 1104b spaced compression members and that is configured to urge the compression members 1104a, 1104b towards one another. Each biasing device 1137 includes either one spring element 1150 or two spring elements 1150.

In FIG. 11A, the biasing device 1137 includes a leaf spring element 1150 that is mounted at one end to the second compression member 1104b and at another end to a pivoting arm 1163 (which is mounted to the first compression member 1104a). The spring element 1150 bends in response to movement of the compression members 1104a, 1104b away from one another.

In the variation of FIG. 11B, two leaf spring elements 1150 extend from the second compression member 1104b and are provided with rollers (or e.g. sliding elements) that move across respective convex cam surfaces 1153, which face away from the second compression member 1104b (and are mounted to and face towards the first compression member 1104a).

In the variation of FIG. 11C, two compression spring elements 1150 (mounted to the second compression member 1104b) are provided, and in operation are compressed by respective connecting members 1164 (connecting the spring elements 1150 to linkages 1165) that are constrained (e.g. by rails) to move perpendicularly to the cell stack direction (and away from one another). The connecting members 1164 are driven by the linkages 1165, which are pivotably mounted by a fixed stem 1166 mounted to the first compression member 1104a.

In the variation of FIG. 11D, two compression spring elements 1150 (mounted to the second compression member 1104b) are provided and, in operation are compressed in a direction perpendicular to the cell stack direction by rollers 1167 that are guided across respective convex cam surfaces 1153 (which are mounted to the first compression member 1104a and face the first compression member 1104a).

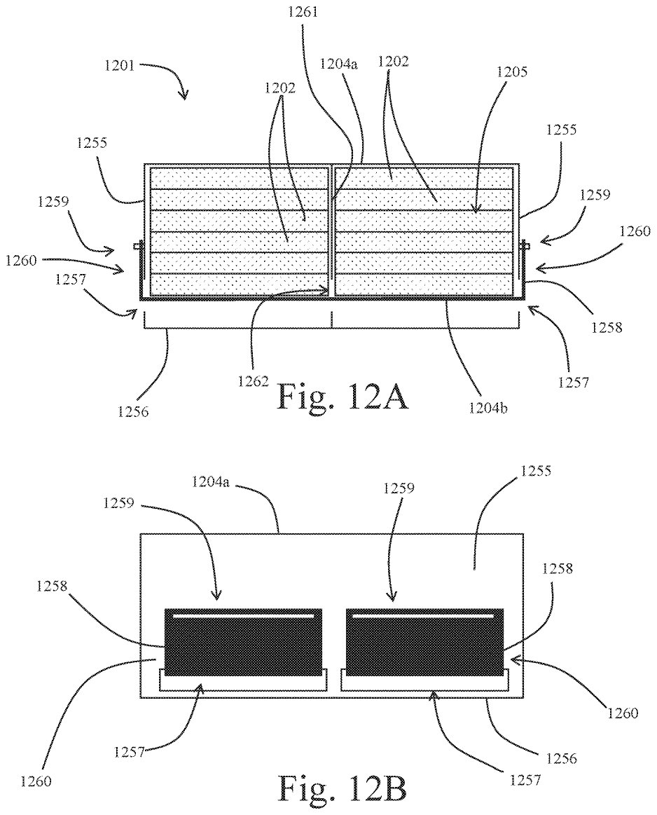

FIGS. 12A and 12B depict a further embodiment in which the pouch cell enclosure 1201 includes lateral sidewalls 1255 extending between an upper wall (which forms a first compression member 1204a) and a lower wall 1256. Each sidewall 1255 has two apertures 1257 formed therein. The enclosure 1201 is also provided with two elastic members 1258, each having opposite ends 1259, that are fixed to a respective one of the sidewalls 1255 (at an outer surface of the sidewall 1255) at locations above the apertures 1257. Intermediate the ends, the elastic members each extend through the apertures 1257 in the sidewalls 1255 and across an interior of the pouch cell enclosure 1201. In this way, each elastic member 1258 includes two end portions 1259 extending in the cell-stack direction along the two sidewalls 1255, and an intermediate laterally-extending portion (which provides a second compression member 1204b) that extends across the pouch cell enclosure 1201 between the lateral sidewalls 1255.

A cell-receiving space 1205 is defined between the second compression members 1204b (defined by the elastic members 1258) and the first compression member 1204a (provided by the upper wall). The biasing arrangement thus is provided by the two end portions 1260 of the elastic members 1258 which urge the second compression member 1204b towards the first compression member 1204a. As may be appreciated, in other embodiments, the laterally-extending portion of each elastic member may be replaced by a separate e.g. rigid component (such as a plate).

To permit expansion and contraction of the pouch cells 1202 held in the cell-receiving space 1205, each aperture 1257 formed in the sidewalls 1255 is configured to allow movement of the part of the elastic member 1258 passing therethrough in the cell stack direction. In other words, the height of each aperture 1257 is significantly greater than the thickness of each elastic member 1258.

The present embodiment also differs from those previously described in that it includes a central wall 1261 interposed between the sidewalls 1255 so as to divide the cell-receiving space 1205 into two regions (although, of course, the present embodiment could be provided without such a central wall and with a single stack of pouch cells). Each of these regions includes a respective stack of pouch cells 1202 (i.e. unlike previous embodiments two stacks of pouch cells 1202 are provided in a side-by side manner). The central wall 1261 includes apertures 1262 to accommodate the elastic member 1258.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A battery comprising:
one or more pouch cells; and
a pouch cell enclosure comprising:
first and second compression members spaced apart in a cell stack direction so as to define a cell-receiving space therebetween in which the one or more pouch cells are received, the first and second compression members being moveable relative to one another in the cell stack direction; and
a biasing arrangement connecting the first and second compression members and configured to urge the first and second compression members towards one another.

2. The battery according to claim 1, wherein the biasing arrangement is disposed at a periphery of the cell-receiving space.

3. The battery according to claim 1, wherein the biasing arrangement comprises a resilient spring member having a first end connected to the first compression member and a second end connected to the second compression member.

4. The battery according to claim 3, wherein the spring member is configured to flex between:
an expanded configuration; and
a contracted configuration in which the first and second ends are closer to one another in the cell stack direction than in the expanded configuration; and
wherein the spring member is biased towards the contracted configuration.

5. The battery according to claim 4, wherein the biasing arrangement is disposed at a periphery of the cell-receiving space, and wherein the resilient spring member is configured to extend at least partly along the periphery of the cell-receiving space.

6. The battery according to claim 5, wherein the spring member is configured to flex between the expanded and contracted configurations by bending in a plane that is substantially perpendicular to the direction of extension of the spring member along the periphery of the cell-receiving space.

7. The battery according to claim 6, wherein the spring member comprises a body extending between the first and second compression members.

8. The battery according to claim 7, wherein the spring member is configured such that the body has a concave profile in at least the contracted configuration.

9. The battery according to claim 8, wherein the spring member is configured to flex such that a radius of curvature of the concave profile of the spring member is greater in the expanded configuration than in the contracted configuration.

10. The battery according to claim 7, wherein the spring member is expandable from the contracted configuration to a position in which the body is substantially planar.

11. The battery according to claim 7, wherein the spring member comprises an arm extending laterally from the body so as to engage the first compression member and so as to define the first end of the spring member, the arm being configured to pivot towards and away from the body when the spring member flexes between the contracted and expanded configurations, and wherein the arm is closer to the body in the contracted configuration than in the expanded configuration.

12. The battery according to claim 11, wherein the arm is a first arm and the spring member comprises a second arm extending laterally from the body so as to engage the second compression member and so as to define the second end of the spring member, the second arm being configured to pivot towards and away from the body when the spring member flexes between the contracted and expanded configurations, and wherein the second arm is closer to the body in the contracted configuration than in the expanded configuration.

13. The battery according to claim 7, wherein the body comprises a resilient impact absorbing element projecting from the body in an at least partly lateral direction, the impact absorbing element configured to bend in response to an impact on the pouch cell enclosure in the lateral direction.

14. The battery according to claim 6, wherein the spring member is formed of metal sheet.

15. The battery according to claim 5, wherein the spring member is configured to flex between the expanded and contracted configurations by bending in a plane that is substantially parallel to the direction of extension of the spring member along the periphery of the cell-receiving space.

16. The battery according to claim 15, wherein the spring member comprises a flexible structure provided between the first and second ends of the spring member, the flexible structure being collapsible in the cell stack direction to provide movement of the spring member between the expanded and contracted positions.

17. The battery according to claim 1, wherein the biasing arrangement is configured to move between expanded and contracted configurations, the biasing arrangement being biased towards the contracted configuration in which the first and second compression members are closer together in the cell stack direction than in the expanded configuration, and wherein the biasing arrangement is configured to provide a substantially constant restoring force as it is moved from the contracted configuration to the expanded configuration.

18. The battery according to claim 1, wherein the biasing arrangement comprises an elastic member arranged to urge the first and second compression members towards one another.

19. The battery according to claim 18, wherein a portion of the elastic member extends laterally across the pouch cell enclosure, the laterally-extending portion of the elastic member providing the second compression member.

20. A pouch cell enclosure for enclosing one or more pouch cells, the pouch cell enclosure comprising:
first and second compression members spaced apart in a cell stack direction so as to define a cell-receiving space therebetween for receipt of one or more pouch cells, the first and second compression members being moveable relative to one another in the cell stack direction; and
a biasing arrangement connecting the first and second compression members and configured to urge the first and second compression members towards one another.
